(19) United States
(12) Patent Application Publication
(10) Pub. No.: US 2018/0031936 A1
(43) Pub. Date: Feb. 1, 2018

(54) ELECTRO-OPTICAL DEVICE AND ELECTRONIC APPARATUS

(71) Applicant: SEIKO EPSON CORPORATION, Tokyo (JP)

(72) Inventors: Shinta ENAMI, Matsumoto-shi (JP); Katsutoshi UENO, Chino-shi (JP)

(73) Assignee: SEIKO EPSON CORPORATION, Tokyo (JP)

(21) Appl. No.: 15/640,815

(22) Filed: Jul. 3, 2017

(30) Foreign Application Priority Data
Jul. 26, 2016 (JP) 2016-146309

(51) Int. Cl. G02F 1/1362; G09G 3/36; G02F 1/1343; G02F 1/1345

(52) U.S. Cl. CPC G02F 1/136286; G02F 1/13452; G09G 3/3677; G02F 1/134336; G09G 2330/02; G09G 2300/0452; G02F 2001/134345; G09G 2300/0426; G02F 1/1368

(57) ABSTRACT

An electro-optical device includes a first substrate, a first terminal group in which a first video signal input terminal and a first non-video signal input terminal are arranged in a peripheral portion of the first substrate in a first direction, a second terminal group in which a second video signal input terminal and a second non-video signal input terminal are arranged in a second direction different from the first direction with respect to the first terminal group and are arranged in the peripheral portion of the first substrate in the first direction, and a first wiring that connects the first non-video signal input terminal and the second non-video signal input terminal.

### BACKGROUND

### 1. Technical Field

The present invention relates to an electro-optical device and an electronic apparatus.

### 2. Related Art

A technique for packaging an electro-optical device such as a liquid crystal panel by using a Flexible Printed Circuit (FPC) substrate is known. For example, JP-A-2008-160038 describes a technique of packaging an IC chip and an FPC substrate on a glass substrate.

In recent years, with the high resolution of an electro-optical device, the number of terminals used for packaging tends to increase. In addition, due to demands for downsizing and high definition, there is a limit to an area that can be used as terminals, and wirings also tend to be thin. However, when a power line becomes thinner, there is a case that a source voltage is not stabilized, hindering an operation of the electro-optical device.

### SUMMARY

An advantage of some aspects of the present invention is to provide an electro-optical device capable of downsizing, securing a higher quality power supply, and display with high definition and high quality.

According to an aspect of the invention, there is provided an electro-optical device that includes a first substrate, a first terminal group in which a first video signal input terminal and a first non-video signal input terminal are arranged in a peripheral portion of the first substrate in a first direction, a second terminal group in which a second video signal input terminal and a second non-video signal input terminal are arranged in a second direction different from the first direction with respect to the first terminal group and are arranged in the peripheral portion of the first substrate in the first direction, and a first wiring that connects the first non-video signal input terminal and the second non-video signal input terminal.

In the aspect of the electro-optical device described above, it is preferable that the first video signal input terminal be connected to a first video signal line extending in the second direction, the second video signal input terminal be connected to a second video signal line extending in the second direction, and the first video signal line and the second video signal line be not connected.

In the aspect of the electro-optical device described above, it is preferable that the second non-video signal input terminal be connected to a second non-video signal line extending in the second direction.

In the aspect of the electro-optical device described above, it is preferable that the first wiring have a thicker wiring width than the first video signal line and the second video signal line.

In the aspect of the electro-optical device described above, it is preferable that the first non-video signal line have a thicker wiring width than the first video signal line and the second video signal line.

In the aspect of the electro-optical device described above, it is preferable that the first video signal input terminal and the second video signal input terminal have the same position in the first direction, and the first non-video signal input terminal and the second non-video signal input terminal have the same position in the first direction.

In the aspect of the electro-optical device described above, it is preferable that the first terminal group be arranged in the peripheral area on one side of the first substrate, and the second terminal group be arranged on the substrate end side with respect to the first terminal group in the peripheral area on one side of the first substrate.

In the aspect of the electro-optical device described above, it is preferable that the electro-optical device be provided with a first wiring substrate that supplies video signals to a first pixel group and a second wiring substrate that supplies video signals to a second pixel group, and the first wiring substrate be connected to the first terminal group and the second wiring substrate be connected to the second terminal group.

In the aspect of the electro-optical device described above, it is preferable that the first non-video signal input terminal be supplied with a source voltage from the first wiring substrate, and the second non-video signal input terminal be supplied with the same source voltage from the second wiring substrate.

In the aspect of the electro-optical device described above, it is preferable that the electro-optical device include a scanning line drive circuit provided in the peripheral portion of the first substrate, and the first wiring substrate be provided with a first drive circuit and the second wiring substrate be provided with a second drive circuit.

According to the aspect described above, it is possible to realize the electro-optical device which can be downsized, securing high quality power supply, and display with high definition and high quality.

According to another aspect for the invention, there is provided an electro-optical device including a first substrate, a first terminal group that includes a first video signal input terminal and a first power supply terminal and is arranged in the first substrate in a first direction, a second terminal group that includes a second video signal input terminal and a second power supply terminal, and is arranged in a second direction different from the first direction with respect to the first terminal group and arranged in the first substrate in the first direction, and the first wiring that is formed on the first substrate and connects the first power supply terminal and the second power supply terminal.

According to the electro-optical device, it is possible to provide power supply with higher quality.

The first wiring may have a thicker wiring width than a wiring connected to the first video signal input terminal and a wiring connected to the second video signal input terminal.

According to the electro-optical device, it is possible to increase the current capacity of the power line as compared with the case where the first wiring has the same thickness as the second wiring and the third wiring.

In addition, the first video signal input terminal and the second video signal input terminal may have the same position in the first direction, and the first power supply terminal and the second power supply terminal may have the same position in the first direction.

In addition, the first terminal group may be arranged in the peripheral area on one side of the first substrate, and the second terminal group may be arranged on the substrate end side with respect to the first terminal group in the peripheral area on one side of the first substrate.

The electro-optical device may include a second substrate that is opposite to the first substrate, an electro-optical layer that is sandwiched between the first substrate and the second substrate, a third power supply terminal and a fourth power supply terminal that are included in the first terminal group, a fifth power supply terminal and a sixth power supply terminal that are included in the second terminal group, a wiring that connects the third power supply terminal and the fifth power supply terminal, a wiring that connects the fourth power supply terminal and the sixth power supply terminal, a plurality of pixels, and a drive circuit for selecting a group of pixels from the plurality of pixels, in which a reference potential of the voltage applied to an electro-optical layer may be given to the first power supply terminal and the second power supply terminal, a reference potential in the drive circuit may be given to the third power supply terminal and the fifth power supply terminal, and a power supply potential in the drive circuit may be given to the fourth power supply terminal and the sixth power supply terminal.

According to the electro-optical device, it is possible to supply three electric power sources with high quality in the electro-optical device.

In addition, the electro-optical device may be provided with the first wiring substrate that is connected to the first terminal group, and the second wiring substrate that is connected to the second terminal group, in which the first wiring substrate and the second wiring substrate may supply a reference potential of the voltage applied to the electro-optical layer, a reference potential in the drive circuit, and a power supply potential in the drive circuit, the first wiring substrate may supply video signals to the first video signal input terminal, and the second wiring substrate may supply video signals to the second video signal input terminal.

Further, the first wiring substrate may be connected to the first terminal group, and the second wiring substrate may be connected to the second terminal group.

In addition, the first wiring substrate may be provided with the first drive circuit, and the second wiring substrate may be provided with the second drive circuit.

In addition, according to still another aspect of the invention, the invention provides an electronic apparatus including one of the electro-optical devices described above.

According to the electronic apparatus, it is possible to provide power supply with higher quality.

### BRIEF DESCRIPTION OF THE DRAWINGS

The invention will be described with reference to the accompanying drawings, wherein like numbers reference like elements.

FIG. 1 is a perspective diagram showing a configuration of an electro-optical device according to one embodiment.

FIG. 2 is a schematic diagram showing a configuration of the electro-optical device.

FIG. 3 is a diagram showing an arrangement of terminal groups on an element substrate.

FIG. 4 is a diagram showing a connection relationship between a video signal input terminal and pixels.

FIGS. 5A and 5B are diagrams showing a configuration of an electro-optical panel according to a comparative example.

FIG. 6 is a diagram showing a wiring configuration of power supply terminals.

FIG. 7 is a diagram showing a wiring configuration of the power supply terminals.

FIG. 8 is a diagram showing an equivalent circuit of pixels and a data line selection circuit.

FIG. 9 is a timing chart showing an example of the operation of an electro-optical device.

FIG. 10 is a diagram showing a projector according to one embodiment.

### DESCRIPTION OF EXEMPLARY EMBODIMENTS

### 1. Structure

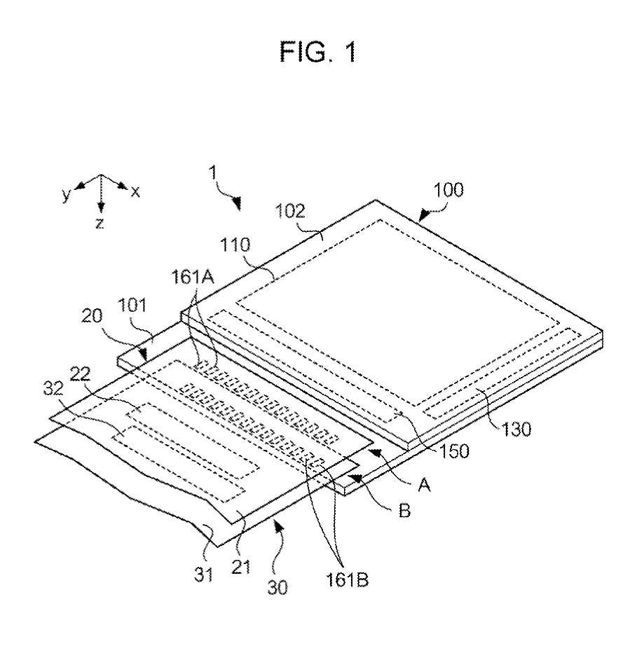

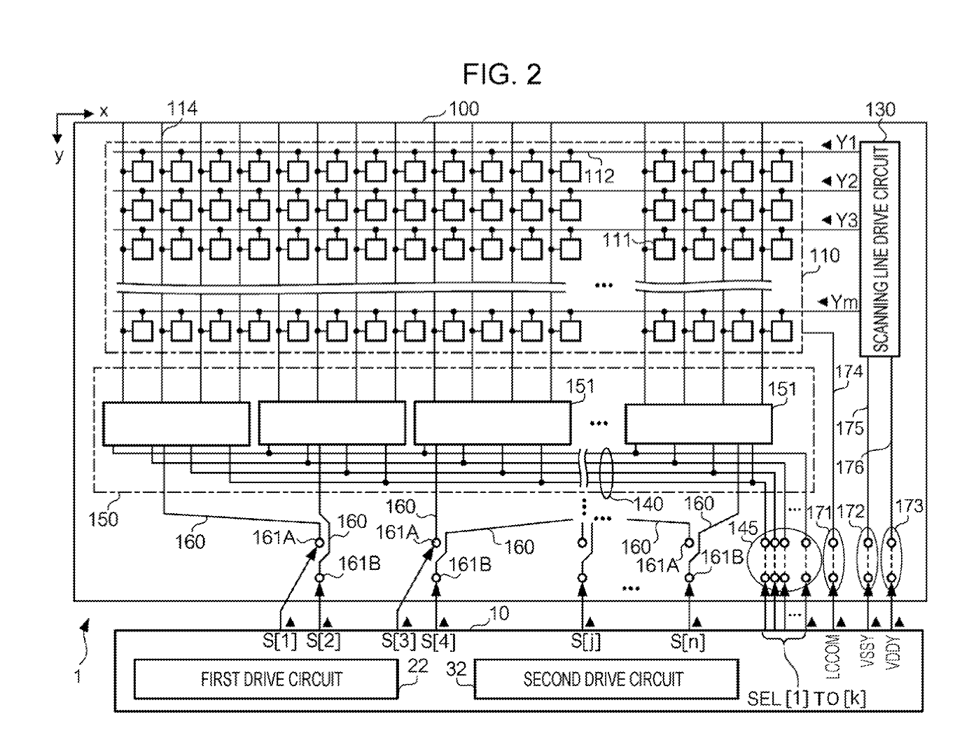

FIG. 1 is a perspective diagram showing a configuration of the electro-optical device 1 according to one embodiment, and FIG. 2 is a schematic diagram showing a configuration of the electro-optical device 1. The electro-optical device 1 includes an electro-optical panel 100, a first wiring substrate 20, and a second wiring substrate 30. The electro-optical device 1 is a device used for displaying an image, and used as a light valve of a projector as one example.

The electro-optical panel 100 changes the optical state thereof according to a given signal, that is, forms an image. In this example, the electro-optical panel 100 is a transparent liquid crystal panel. The electro-optical panel 100 includes an element substrate 101, an opposing substrate 102, and a liquid crystal (not shown in the diagram). The element substrate 101 and the opposing substrate 102 are stuck together with a gap therebetween. The liquid crystal is sealed in this gap and forms a liquid crystal layer. The liquid crystal is, for example, a Vertical Alignment (VA) type liquid crystal. The element substrate 101 (an example of the first substrate) is a substrate where a pixel electrode (not shown in the diagram) and a circuit element (a transistor, or the like, not shown in the diagram) for writing a voltage to the pixel electrode thereof are formed. The opposing substrate 102 (an example of the second substrate) is a substrate where a common electrode (not shown in the diagram) is formed. Both the element substrate 101 and the opposing substrate 102 are formed of a light-transmitting material such as glass or quartz.

The first wiring substrate 20 and the second wiring substrate 30 are for connecting the electro-optical panel 100 to another device such as a circuit board. The first wiring substrate 20 includes a wiring formed on a Flexible Printed Circuit (FPC) substrate 21 and a first drive circuit 22. The second wiring substrate 30 includes a wiring formed on an FPC substrate 31 and a second drive circuit 32. The first wiring substrate 20 and the second wiring substrate 30 are a so-called Chip On Film (COF). The first wiring substrate 20 includes a connection area (not shown) for connecting with a terminal group A including a video signal input terminal 161A and the like of the electro-optical panel 100. The second wiring substrate 30 includes a connection area (not shown) for connecting with a terminal group B including a video signal input terminal 161B and the like of the electro-optical panel 100. Due to the terminal groups and the connection areas, the electro-optical panel 100 is electrically connected to the first wiring substrate 20 and the second wiring substrate 30.

The electro-optical panel 100 includes a pixel area 110, a scanning line drive circuit 130, a data line selection circuit 150, n pieces of video signal lines 160, n pieces of video signal input terminals 161, k pieces of selection signal lines 140, k pieces of selection signal input terminals 145, a plurality of power supply terminals 171, 172, and 173, and corresponding power lines 174, 175, and 176. n is an integer of 1 or more, and k is an integer of 2 or more. In the example of FIG. 2, k=4. These elements are formed on the element substrate 101. The data line selection circuit 150 is formed along one side of a peripheral portion of the pixel area 110 of the element substrate 101, and the scanning line drive circuit 130 is formed along another side that intersects the side where the data line selection circuit 150 is formed. The terminal groups A and B are formed on the side opposite to the pixel area 110, that is, on the end side of the substrate with respect to the data line selection circuit 150.

In this example, a drive circuit 10 including the first drive circuit 22 and the second drive circuit 32 is used to drive a large number of pixels of high definition display at high speed. The first drive circuit 22 and the second drive circuit 32 output the video signal indicating the image to be displayed on the electro-optical panel 100 according to a clock signal, a control signal, and a video signal input from an external upper circuit. The electro-optical panel 100 displays the image according to the clock signal and the video signal input from the first drive circuit 22 and the second drive circuit 32, and other circuits. In this example, the first drive circuit 22 and the second drive circuit 32 are a drive circuit with the same function, and it is possible to output the same signal except a data signal.

The pixel area 110 is an area for displaying an image. The pixel area 110 includes m pieces of scanning lines 112, (k×n) pieces of data lines 114, and (m× k×n) pieces of pixels 111. m is an integer of 1 or more. The pixels 111 are provided corresponding to the intersection of the scanning line 112 and the data line 114 and arranged in a matrix of m rows× (k×n) columns. The scanning line 112 is a signal line transmitting a scanning signal and is provided along the row direction (x direction) from the scanning line drive circuit 130. The data line 114 is a signal line for transmitting a data signal and is provided in the column direction (y direction) from the data line selection circuit 150. The scanning line 112 and the data line 114 are electrically insulated. In addition, in this example, (k× m) pieces of pixels 111 corresponding to k pieces (columns) of data lines 114 form one a pixel group (block). Considering the pixels 111 in one column as one a sub-pixel group, one pixel group is formed of k pieces (columns) of sub-pixel groups. The pixels 111 belonging to a pixel group are connected to the same video signal line 160 via the data line selection circuit 150. That is, the electro-optical panel 100 includes n pieces (columns) of pixel groups divided into n pieces of blocks by n pieces (columns) of video signal lines 160 or n pieces of video signal input terminals 161. The details of the pixels 111 will be described later. In the following description, when it is necessary to distinguish each of the plurality of the scanning lines 112, each scanning line is expressed as the scanning line 112 in the first row, the second row, the third row, . . . , and the m-th row. When it is necessary to distinguish each of the plurality of the data lines 114, each date line is expressed as the data line 114 in the first column, the second column, the third column, . . . , and the (k×n)th column. The same applies to the video signal line 160. In addition, in this example, the k pieces of sub-pixel groups forming one pixel group or the corresponding k pieces of data lines 114 are sequentially arranged in the row direction, but the sub-pixel groups or the data lines are not necessarily sequentially arranged. In this example, since the k pieces of data lines 114 are continuous in the row direction, it is possible to prevent the video signal lines 160 from intersecting with each other, or the video signal line 160 from intersecting with a wiring affecting a data signal.

The scanning line drive circuit 130 selects a row to write data out of a plurality of the pixels 111 arranged in a matrix. Specifically, the scanning line drive circuit 130 outputs a scanning signal for selecting one scanning line 112 from the plurality of the scanning lines 112. The scanning line drive circuit 130 supplies the scanning signals Y1, Y2, Y3, . . . , and Ym to the scanning line 112 in the first row, the second row, the third row, . . . , and the m-th row. In this example, the scanning signals Y1, Y2, Y3, . . . , and Ym are signals which are of an exclusively sequential at high level.

The data line selection circuit 150 selects the columns of the pixels 111 in which data is written in each pixel group. Specifically, the data line selection circuit 150 selects at least one data line 114 from the k pieces of data lines 114 belonging to the pixel group according to selection signals SEL[1] to SEL[k]. The data lines 114 are connected to the video signal lines 160, one by one, in units of k pieces of data lines by the data line selection circuit 150. The data line selection circuit 150 includes n pieces of demultiplexers 151 corresponding to each of the n pixel groups. The details of the demultiplexer 151 will be described later.

The video signal line 160 connects between a video signal input terminal 161 and the data line selection circuit 150. The video signal line 160 is a signal line that transmits video signals S (S[1] to S[n]) input from the first wiring substrate 20 and the second wiring substrate 30 via the video signal input terminal 161 to the data line selection circuit 150, and n (columns) pieces of signal lines are provided corresponding to each of the n pieces of video signal input terminals 161 or n pieces of pixel groups. The video signals S are signals indicating data written in the pixels 111. Here, “video” means a still image or a moving image. One video signal line 160 is connected to k pieces of data lines 114 via the data line selection circuit 150. Therefore, in the video signals S, the data supplied to these k pieces of data lines 114 are time-division multiplexed.

The selection signal line 140 connects between the selection signal input terminal 145 and the demultiplexer 151 of the data line selection circuit 150. The selection signal lines 140 (140[1] to 140[k]) are signal lines that transmit the selection signals SEL (SEL[1] to SEL[k]) input from the selection signal input terminals 145 (145[1] to 145[k]), and k pieces of signal lines are provided. The selection signal SEL is a signal which sequentially becomes a signal with a high level.

The video signal input terminal 161 is a terminal (electrode pad) connected to the first wiring substrate 20 and the second wiring substrate 30, and the video signal S[j] is supplied (j is an integer satisfying 1≦j≦n). In this example, the video signals S[1], S[3], S[5], . . . , and S[2t− 1] are supplied to the video signal input terminal 161 corresponding to the video signal lines 160 in odd columns such as the first column, the third column, the fifth column, . . . , and the (2t− 1)th column from the first drive circuit 22 of the first wiring substrate 20 (t is an integer satisfying 1≦ t≦ n/2). In addition, the video signals S[2], S[4], S[6], . . . , and S[2t] are supplied to the video signal input terminal 161 corresponding to the video signal lines 160 in even columns such as the second column, the fourth column, the sixth column, . . . , and the (2t)th column from the second drive circuit 32 of the second wiring substrate 30. The video signal S is a so-called data signal, and in this example, signals having different waveforms according to the display of the image are supplied to the video signal input terminals 161 corresponding to the terminal groups A and B, respectively. For example, the video signal S is an analog signal.

A selection signal input terminal 145 is a terminal (electrode pad) connected to the first wiring substrate 20 and the second wiring substrate 30, and the selection signal SEL is supplied. The selection signal SEL is supplied from both or one of the first drive circuit 22 of the first wiring substrate 20 and the second drive circuit 32 of the second wiring substrate 30. The selection signal SEL is a timing signal for selecting the data line 114 in the data line selection circuit 150, and in this example, selection signals SEL having the same waveform are supplied to the selection signal input terminals 145 corresponding to the terminal groups A and B, respectively. For example, the selection signal SEL is a pulse signal.

The power supply terminal 171, the power supply terminal 172, and the power supply terminal 173 are terminals (electrode pads) connected to the first wiring substrate 20 and the second wiring substrate 30, and a source voltage is supplied. The source voltage is a voltage used as a power source in the electro-optical panel 100, and is a DC voltage in this example. The power supply terminal 171 is a terminal for supplying a voltage LCCOM, the power supply terminal 172 is a terminal for supplying a voltage VSSY, and the power supply terminal 173 is a terminal for supplying a voltage VDDY. The voltage LCCOM is a voltage which is a reference potential of a voltage applied to the liquid crystal layer. The voltage VSSY is a voltage which is the power supply potential on the low voltage side in the scanning line drive circuit 130. The voltage VDDY is a voltage which is the power supply potential on the high voltage side in the scanning line drive circuit 130.

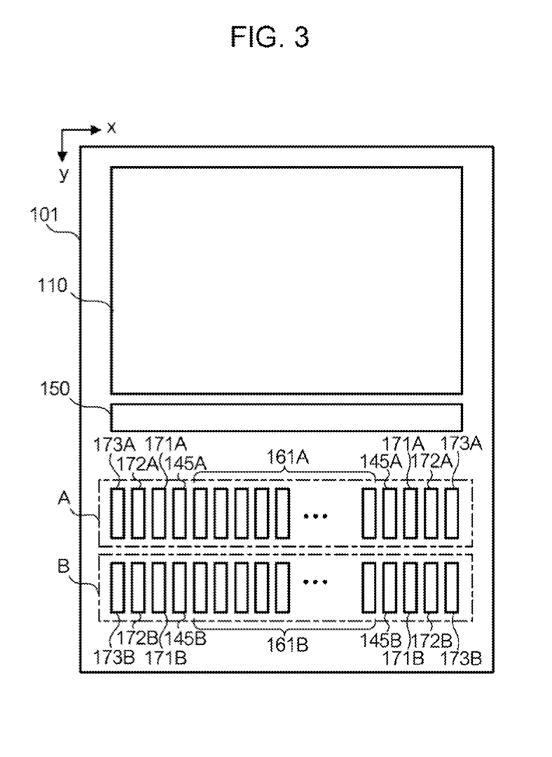

FIG. 3 is a diagram showing the arrangement relationship of the terminal groups A and B in the element substrate 101. As described in FIGS. 1 and 2, the terminal groups A and B are arranged on one side of the peripheral area of the element substrate 101. The terminal group A is the terminal group connected to the first wiring substrate 20, and the terminal group B is the terminal group connected to the second wiring substrate 30. The terminal groups A and B include a plurality of the video signal input terminals 161, a plurality of the selection signal input terminals 145, a plurality of the power supply terminals 171 to 173, and the like. The terminal group B is arranged in the longitudinal direction (column direction) of the element substrate 101 with respect to the terminal group A. In this example, the terminal group B is formed on the side opposite to the pixel area 110 with respect to the terminal group A, that is, on the end side of the substrate.

The terminal group A includes the video signal input terminal 161A, the selection signal input terminal 145A, the power supply terminals 171A to 173A, and each terminal is arranged in a row along the lateral direction (row direction) of the element substrate 101. The terminal group B includes the video signal input terminal 161B, the selection signal input terminal 145B, the power supply terminals 171B to 173B, and each terminal is arranged in a row along the lateral direction of the element substrate 101. The video signal input terminal 161B, the selection signal input terminal 145B, and the power supply terminals 171B to 173B have the same position in the lateral direction and are arranged in the longitudinal direction, respectively, with respect to the video signal input terminal 161A, the selection signal input terminal 145A, and the power supply terminals 171A to 173A, respectively. In addition, in this example, each terminal having the same position of in the lateral direction of the terminal group A and the terminal group B is a terminal to which the same type of signal is input, and the shape of the terminal is also the same.

In addition, the number of the video signal input terminals 161A and the video signal input terminals 161B that are arranged is at least n in total. In this example, the number of the video signal input terminals 161A and the video signal input terminals 161B are the same number, and n/2 pieces of terminals are arranged in the middle of the lateral direction of the terminal group.

k pieces of selection signal input terminals 145A and selection signal input terminals 145B are respectively arranged on both sides of the video signal input terminal 161A and the video signal input terminal 161B (in FIG. 3, only one piece is shown on each side). The selection signal input terminal 145A and the selection signal input terminal 145B are provided on both sides, respectively, and therefore it is possible to input the selection signal SEL from both ends of the selection signal line 140. In addition, by providing the selection signal input terminal 145A and the selection signal input terminal 145B, it is possible to input the selection signal SEL from both or one of the first wiring substrate 20 and the second wiring substrate 30. In addition, as the example in FIG. 2, k pieces of selection signal input terminal 145 may be provided on only one side of the video signal input terminals 161, and the selection signal SEL may be input from one end of the selection signal line 140.

The power supply terminals 171A to 173A and the power supply terminals 171B to 173B are provided on both sides of the video signal input terminal 161A and the video signal input terminal 161B, respectively. This is because, for example, the scanning line drive circuit 130 corresponds to a configuration in which one scanning line drive circuit 130 is provided on each of the left and right sides of the substrate 101. As the example in FIG. 2, in the configuration in which only one scanning line drive circuit 130 is used, the selection signal input terminal 145 and the power supply terminals 171 to 173 may be provided on only one side of the video signal input terminal 161.

Also in FIG. 3, the longitudinal direction is the column direction in which the data line 114 extends in the pixel area 110, that is, the y direction. In addition, the lateral direction is the row direction in which the scanning line 112 extends in the pixel area 110, that is, the x direction. The lateral direction is an example of a first direction, and the longitudinal direction is an example of a second direction. In addition, the first and second directions are the longitudinal direction and the lateral direction with respect to the display of the image of a liquid crystal panel 100, respectively.

The terminal group A is an example of the first terminal group, which in this example is the terminal group for connecting to the first wiring substrate 20, and the video signal input terminal 161A, the selection signal input terminal 145A, and the power supply terminals 171A to 173A are arranged in a row along the lateral direction. The power supply terminal 171A, the power supply terminal 172A, and the power supply terminal 173A are examples of a first power supply terminal, a third power supply terminal, and a fourth power supply terminal, respectively. The terminal group B is an example of the second terminal group, which in this example is the terminal group for connecting to the second wiring substrate 30, and the video signal input terminal 161B, the selection signal input terminal 145B, and the power supply terminals 171B to 173B are arranged in a row corresponding to the terminal group A along the lateral direction. The power supply terminal 171B, the power supply terminal 172B, and the power supply terminal 173B are examples of a second power supply terminal, a fifth power supply terminal, and a sixth power supply terminal, respectively.

In the electro-optical panel 100, the terminal group B is arranged in the longitudinal direction (different position in the y direction) with respect to the terminal group A. By providing the two terminal groups of the terminal group A and the terminal group B, the two terminal groups can be connected to a different wiring substrate (in this example, the first wiring substrate 20 and the second wiring substrate 30), respectively, and it is possible to drive each terminal group with a different drive circuit (the first drive circuit 22 and a second drive circuit 32 in this example).

Further, since the terminal group A and the terminal group B are arranged in the longitudinal direction, as compared with the case where the terminal group A and the terminal group B are arranged in the lateral direction, it is possible to arrange the spacing between the terminals in the lateral direction in a crude manner (widely), or increase the size of each terminal in the lateral direction.

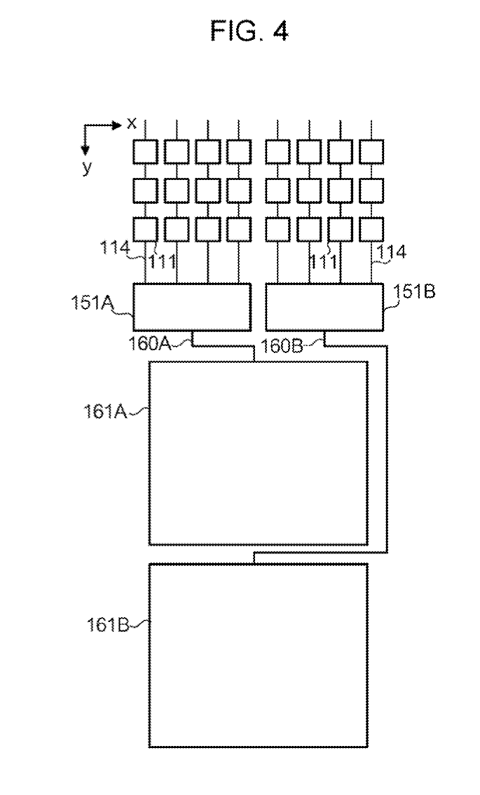

FIG. 4 is a diagram showing the connection relationship between the video signal input terminal 161 and the pixels 111. In FIG. 4, among n pieces of pixel groups and n pieces of video signal input terminals 161 shown in the example of FIG. 2, only two consecutive pixel groups and the two video signal input terminals 161 corresponding thereto are shown. In addition, the video signal lines 160 and the demultiplexers 151 corresponding to the two consecutive pixel groups are also shown. In this example, the video signal input terminals 161 are divided into two groups of terminals including the terminals connected to an odd numbered (odd numbered columns) pixel group (block) and the terminals connected to an even numbered (even numbered columns) pixel group (block). Here, the terminals corresponding to the odd numbered pixel group are the video signal input terminals 161A of the terminal group A, and the terminals corresponding to the even numbered pixel group are the video signal input terminals 161B of the terminal group B. A demultiplexer 151A is the demultiplexer 151 corresponding to the odd numbered pixel group and a demultiplexer 151B is the demultiplexer 151 corresponding to the even numbered pixel group. The video signal input terminals 161A are connected to the data lines 114 of the odd numbered pixel group via the odd numbered video signal lines 160 and the demultiplexer 151A. In addition, the video signal input terminals 161B are connected to the data lines 114 of the even numbered pixel group via the even numbered video signal lines 160 and the demultiplexer 151B. The video signal input terminals 161A and the video signal input terminal 161B are different not only in the connected demultiplexer 151 but also in the wiring substrates (drive circuits) to which the video signal is supplied. In this example, the video signal input terminals 161A and the video signal input terminals 161B are connected to the first wiring substrate 20 and the second wiring substrate 30, respectively, and a video signal is supplied from the first drive circuit 22 and the second drive circuit 32. That is, the video signal input terminals 161A in the first row which is the terminal group A receive video signals S1, S3, S5, . . . , and S(2t− 1) corresponding to the odd numbered pixel group from the first drive circuit 22. In addition, the video signal input terminals 161B in the second row which is the terminal group B receive video signals S2, S4, S6, . . . , and S(2t) corresponding to the even numbered pixel group from the second drive circuit 32. The video signal input terminals 161A of the terminal group A are an example of first video signal input terminals and the video signal input terminals 161B of the terminal group B are an example of second video signal input terminals.

The pixel group connected to the video signal input terminals 161A of the terminal group A is an example of the first pixel group, and the pixel group connected to the video signal input terminals 161B of the terminal group B is an example of the second pixel group. In this example, the first pixel group and the second pixel group are arranged by n/2 pieces in the lateral direction, respectively. Since each the pixel group is provided with k pieces of consecutive data lines 114, the data lines 114 are alternately connected to the video signal input terminals 161A and the video signal input terminals 161B in units of k pieces of consecutive data lines. In addition, the demultiplexer 151 selects a sub-pixel group in one column from the sub-pixel groups in the k columns for each of the first pixel group and the second pixel group. In this example, since k pieces of data lines 114 are consecutive in the row direction, the demultiplexer 151 can be arranged in the row direction (x direction) corresponding to each pixel group, and therefore it is possible to prevent the video signal line 160 from intersecting with each other or the video signal line 160 from intersecting with a wiring affecting a data signal.

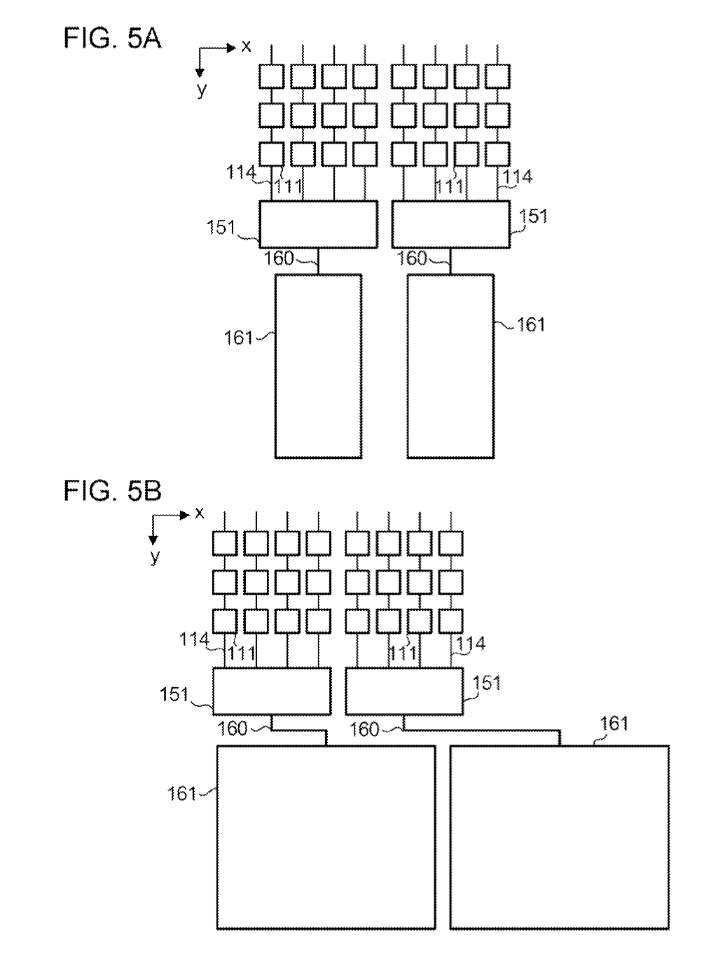

In addition, in this example, one video signal input terminal 161 is connected to four pieces (k=4) of data lines 114 via the data line selection circuit 150. As an example, an example in which four pieces of data lines 114 sequentially arranged in the lateral direction (row direction) with the spacing between the data lines 114 in the pixel area 110 (for example, the distance between the centers of two data lines) set to 6 μm form a block is considered. In the high-definition electro-optical panel 100, the ratio of the video signal input terminal 161 to the size of the arrangement area of the terminal group increases. In the comparative example of FIGS. 5A 5B in which the video signal input terminal 161 is arranged in one row in the lateral direction, in a case where the size (width) of the arrangement area in the lateral direction (approximately, arrangement area of the terminal group) of the pixel area 110 and the video signal input terminal 161 is set to be approximately the same, the spacing between the adjacent video signal input terminals 161 (distance between the centers of the terminals) is 24 μm (4×6 μm) (FIG. 5A). This means that the size of the electrode pad forming the terminals must be less than 24 μm in order to make the size of the arrangement area of the terminal group and the size of the pixel area 110 almost equal, and advanced ability of packaging wiring substrates and electro-optical panels is required, which is not easy. In addition, in a case where the size of the electrode pad is 48 [μm], the size of the terminal group in the lateral direction is at least n×48 [μm], which is about twice as large as n×24 [μm] (n×4× 6 [μm]) corresponding to the size of the pixel area 110 in the lateral direction, and the miniaturization of the electro-optical panel 100 cannot be achieved (FIG. 5B). However, in an example in which the video signal input terminals 161A and the video signal input terminals 161B are arranged in two rows in the longitudinal direction as in the present embodiment, the spacing between the adjacent video signal input terminals 161A can be 48 [μm], and the width that can be used as one electrode pad is increased to about twice that of the comparative example, which makes packaging easier. In addition, even if the size of the electrode pad is about 48 [μm], the size of the arrangement area of the video signal input terminal 161 in the lateral direction is n×24 [μm] (n/2×48 [μm]), which is equivalent to n×24 [μm] (n×4× 6 [μm]) corresponding to the size of the pixel area 110 in the lateral direction.

If the spacing (pitch) between the data lines 114 is set to d [μm], the spacing (pitch) between the electrode pads of the video signal input terminals 161 is set to p [μm], the number of the terminal groups arranged in the longitudinal direction, that is the number of wiring substrates to which the terminal groups are connected is set to c [pieces], the size of the pixel area 110 in the lateral direction is at least k×n× d [μm], and the size in the lateral direction necessary for arranging the video signal input terminal 161 is at least n/c× p [μm]. (n/c× p<k× n× d) for reducing the size in the lateral direction necessary for arranging the video signal input terminal 161 in one row with respect to the size of the pixel area 110 in the lateral direction, is effective for downsizing the electro-optical panel. That is, if c, p, k and d are determined so as to satisfy the relationship of p/c<k× d, it is possible to realize the electro-optical device 1 in the small size and high definition without depending largely on the capability of the drive circuit, ability of packaging wiring substrates and electro-optical panels, and the like. For example, if k=8, c=2, n=520, and d=6 [μm], the number of the data lines 114 is 4,160 pieces (8×520 pieces), the electro-optical panel 100 can be realized in the small size and high definition with the size of the pixel area 110 in the lateral direction being 24,960 [μm] (6× 4,160 [μm]). In this case, the size of one row of the arrangement area of the video signal input terminal 161 in the lateral direction is 260× p [μm] (520/2× p [μm]) and the spacing p between the electrode pads is 96 [μm](24,960/260 [μm]), which makes packaging easier. Further, in a case where the size (width) of the electrode pad is set to 56 [μm], the gap in the lateral direction between the electrode pads is 40 μm, a video signal line 160B of about 10 [μm] (for example, 8 to 12 [μm]) can be easily arranged between the video signal input terminals 161A, and routing of wirings from the terminal group arranged in the longitudinal direction becomes also easier.

By respectively connecting the two wiring substrates (the first wiring substrate 20, the second wiring substrate 30) respectively provided with the drive circuits (the first drive circuit 22, the second drive circuit 32) that are capable of outputting 260 video signals to the terminal groups A and B in two rows, it is easy to package the terminals and to drive 4,160 (8×2× 260) pieces of data lines 114 corresponding to high definition display.

Further, in this example, the pixel group driven by the first drive circuit 22 and the pixel group driven by the second drive circuit 32 are alternately arranged. In other words, the data lines 114 are alternately arranged for every k pieces, one data lines connected to the first drive circuit 22 and the one other data lines connected to the second drive circuit 32. As a result, for example, as compared with a case where the left half of the entire data lines 114 is connected to the first drive circuit 22 and the right half thereof is connected to the second drive circuit 32, it is possible to suppress the display unevenness due to the variation in the characteristics of the drive circuit.

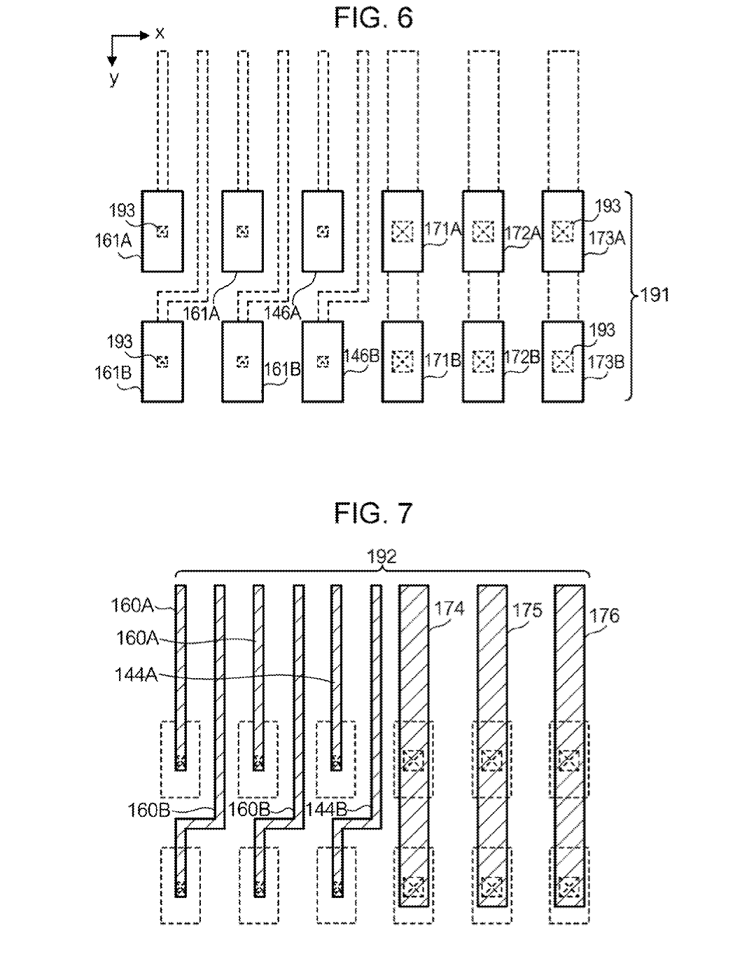

FIGS. 6 and 7 are diagrams showing a wiring configuration of the power supply terminals 171 to 173 in an area where the terminal group of the element substrate 101 is formed. Each terminal and wiring is formed by a multilayer wiring technique and is formed by a plurality of wiring layers including at least a wiring layer 191 and a wiring layer 192. FIG. 6 shows the wiring layer 191, and FIG. 7 shows the wiring layer 192 with a solid line, respectively. The wiring layer 191 and the wiring layer 192 are wiring layers laminated in a direction perpendicular to the element substrate 101, and an interlayer insulation film is formed between both layers. A contact hole 193 is formed to establish electrical connection between the wiring layer 191 and the wiring layer 192. The wiring layer 191 is a wiring layer formed on the side farther from the substrate of the element substrate 101 than the wiring layer 192, and constitutes main portions of the video signal input terminal 161, the selection signal input terminal 145, and the power supply terminals 171 to 173. In this example, the wiring layer 191 is exposed on the surface of the element substrate 101 to form a terminal and is connected to the connection area of the first wiring substrate 20 and the second wiring substrate 30. The wiring layer 192 is a wiring layer formed on the substrate side of the element substrate 101 than the wiring layer 191, and constitutes main portions of the video signal line 160, the selection signal line 140, and the power lines 174 to 176.

Since the video signal input terminal 161A and the video signal input terminal 161B are terminals to which the video signal S is input, different data signals are respectively supplied. Therefore, it is necessary that both terminals are insulated. In the wiring layer 192, the video signal line 160A connected to the video signal input terminal 161A and the video signal line 160B connected to the video signal input terminal 161B are separate wirings, and one signal line has a shape bypassing the other signal line.

In contrast, the power supply terminal 171A and the power supply terminal 171B are connected (short-circuited) in the wiring layer 192. The power supply terminal 172A and the power supply terminal 172B, and the power supply terminal 173A and the power supply terminal 173B are similarly connected in the wiring layer 192, respectively. The voltage supplied to the power supply terminals 171 to 173 is common to the first wiring substrate 20 and the second wiring substrate 30, and since the voltage is a DC voltage that does not change with time, there is no problem even if the terminal group A and the terminal group B are short-circuited.

In addition, with respect to the power supply terminals 171 to 173, since the same wiring can be used for the terminal group A and the terminal group B, it is possible to make a width per wiring thicker than that of the video signal line 160 in power lines 174 to 176. By making the power lines 174 to 176 thick, the current capacity increases, and it is possible to stabilize and strengthen the power supply quality. The wiring layer 192 constituting the power line 174 is an example of the first wiring connecting the power supply terminal 171A and the power supply terminal 171B. The wiring layer 192 constituting the video signal line 160A is an example of the second wiring connected to the video signal input terminal 161A. The wiring layer 192 constituting the video signal line 160B is an example of the third wiring connected to the video signal input terminal 161B. The wiring layer 192 constituting the power line 175 is an example of the fourth wiring connecting the power supply terminal 172A and the power supply terminal 172B. The wiring layer 192 constituting the power line 176 is an example of the fifth wiring connecting the power supply terminal 173A and the power supply terminal 173B. Although the selection signal SEL is basically common to the first drive circuit 22 and the second drive circuit 32, the selection signal SEL is a signal that changes with time. In a case where there is a delicate difference in operation timing between the first drive circuit 22 and the second drive circuit 32, there is a possibility of the first drive circuit 22 and the second drive circuit 32 being adversely affected. In this example the selection signal input terminal 145A and the selection signal input terminal 145B are insulated.

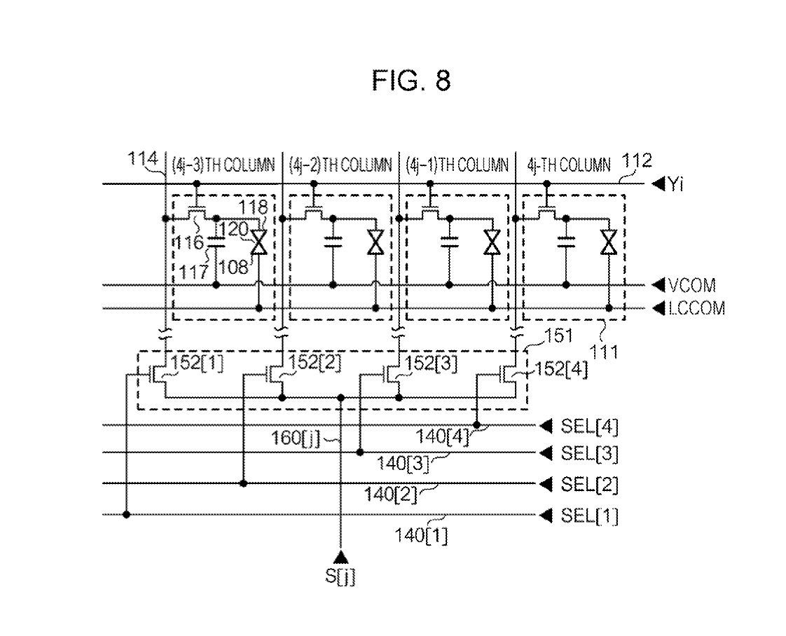

FIG. 8 is a diagram showing an equivalent circuit of the demultiplexer 151 of the pixels 111 and the data line selection circuit 150. In FIG. 8, the pixels 111 in the (k× j− k+1)th column to the (k× j)th column of the i-th row of the pixel area 110 and the demultiplexer 151 corresponding thereto are shown (i is an integer satisfying 1≦i≦m). In the i-th row, one block is form of k pieces (k=4 in this example) of consecutive pixels 111. The pixels 111 include a Thin Film Transistor (TFT) 116, a pixel electrode 118, a liquid crystal layer 120, a common electrode 108, and a retention volume 117. The TFT 116 is a switching element for controlling writing (application of voltage) data to the pixel electrode 118, and in this example, is an n-channel type field effect transistor. The gate electrode of the TFT 116 is connected to the scanning line 112, the source electrode is connected to the data line 114, and the drain electrode is connected to the pixel electrode 118. When the scanning line 112 is supplied with a high level of scanning signal, the TFT 116 is turned on and the data line 114 and the pixel electrode 118 are brought into a low impedance state. That is, data is written in the pixel electrode 118. When the scanning line 112 is supplied with a low level of scanning signal, the TFT 116 is turned off and the data line 114 and the pixel electrode 118 are brought into a high impedance state. The common electrode 108 is common to all the pixels 111. The common voltage LCCOM is applied to the common electrode 108, for example, by the first drive circuit 22 and the second drive circuit 32. A voltage corresponding to the potential difference between the pixel electrode 118 and the common electrode 108 is applied to the liquid crystal layer 120, and an optical characteristic (transmittance or reflectance) is changed according to the voltage. The retention volume 117 is connected in parallel with the liquid crystal layer 120 and holds electric charge corresponding to the potential difference between the pixel electrode 118 and the common voltage VCOM (in this example, VCOM=LCCOM). Hereinafter, when distinguishing each of the elements included in the pixels 111 in a particular pixel group, the elements are distinguished by TFT 116[s] (s is an integer satisfying 1≦s≦k).

The demultiplexer 151 is a circuit for supplying the video signal S to the data line 114 selected according to the selection signals SEL[1] to SEL[k]. The video signal S input from the video signal input terminal 161 is supplied to the demultiplexer 151 via the video signal line 160. One demultiplexer 151 includes one video signal input unit, k pieces of selection signal input units, k pieces of video signal output units, k pieces of TFTs 152 (152[1] to 152[k]), and one video signal input terminal 161 via the video signal line 160 and k pieces of selection signal input terminals 145 (145[1] to 145[k]) via the selection signal line 140 are connected with k pieces of data line 114. The TFT 152 is a switching element for selecting the data line 114 according to the selection signal SEL input to the gate.

The gate electrode of the TFT 152[1] is connected to the selection signal line 140[1], the source electrode is connected to the video signal line 160 in the j-th column, the drain electrode is connected to the data line 114 in the (4j− 3)th column (that is, the source electrode of the TFT 116[1] in the j-th pixel group). When a high level of selection signal SEL[1] is supplied to the selection signal line 140[1], the TFT 152 is turned on, and the video signal line 160 in the j-th column and the data line 114 in the (4j− 3)th column are brought into a low impedance state and become conductive. That is, the video signal S[j] is supplied to the data line 114 in the (4j− 3)th column. When a low level of selection signal SEL[1] is supplied to the selection signal line 140[1], the TFT 152[1] is turned off, and the video signal line 160 in the j-th column and the data line 114 in the (4j− 3)th column are brought into a high impedance state.

The gate electrode of the TFT 152[2] is connected to the selection signal line 140[2], the source electrode is connected to the video signal line 160 in the j-th column, the drain electrode is connected to the data line 114 in the (4j− 2)th column (that is, the source electrode of the TFT 116[2] in the j-th pixel group). When a high level of selection signal SEL[2] is supplied to the selection signal line 140[2], the TFT 152[2] is turned on, and the video signal line 160 in the j-th column and the data line 114 in the (4j− 2)th column become conductive. That is, the video signal S[j] is supplied to the data line 114 in the (4j−2)th column. When a low level of selection signal SEL[2] is supplied to the selection signal line 140[2], the TFT 152[2] is turned off, and the video signal line 160 in the j-th column and the data line 114 in the (4j− 2)th column are brought into a high impedance state.

The gate electrode of the TFT 152[3] is connected to the selection signal line 140[3], the source electrode is connected to the video signal line 160 in the j-th column, the drain electrode is connected to the data line 114 in the (4j− 1)th column (that is, the source electrode of the TFT 116[3] in the j-th pixel group). When a high level of selection signal SEL[3] is supplied to the selection signal line 140[3], the TFT 152[3] is turned on, and the video signal line 160 in the j-th column and the data line 114 in the (4j− 1)th column become conductive. That is, the video signal S[j] is supplied to the data line 114 in the (4j−1)th column. When a low level of selection signal SEL[3] is supplied to the selection signal line 140[3], the TFT 152[3] is turned off, and the video signal line 160 in the j-th column and the data line 114 in the (4j− 1)th column are brought into a high impedance state.

The gate electrode of the TFT 152[4] is connected to the selection signal line 140[4], the source electrode is connected to the video signal line 160 in the j-th column, the drain electrode is connected to the data line 114 in the 4j-th column (that is, the source electrode of the TFT 116[4] in the pixel group in th j-th column). When a high level of selection signal SEL[4] is supplied to the selection signal line 140[4], the TFT 152[4] is turned on, and the video signal line 160 in the j-th column and the data line 114 in the 4j-th column become conductive. That is, the video signal S[j] is supplied to the data line 114 in the 4j-th column. When a low level of selection signal SEL[4] is supplied to the selection signal line 140[4], the TFT 152[4] is turned off, and the video signal line 160 in the j-th column and the data line 114 in the 4j-th column are brought into a high impedance state.

### 2. Operation

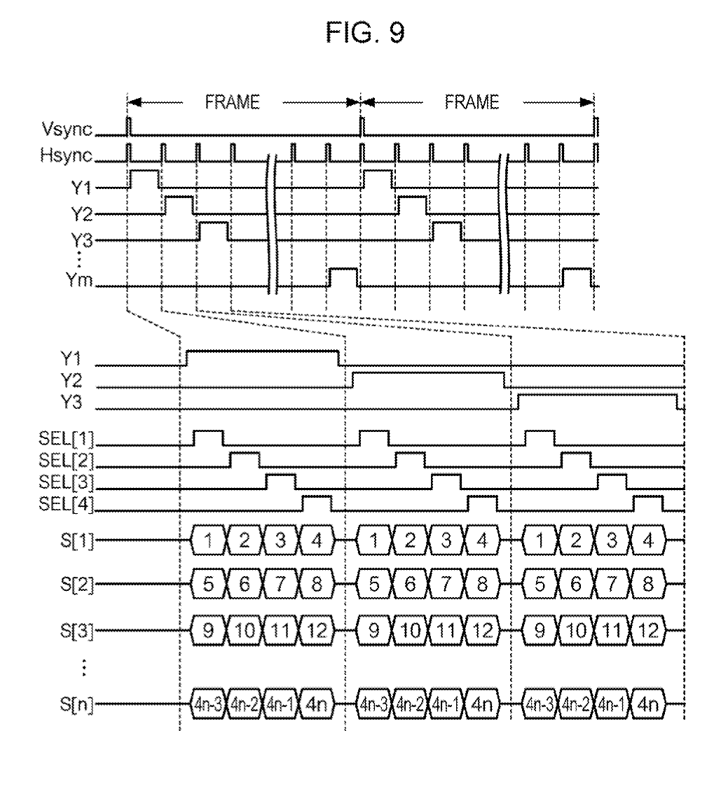

FIG. 9 is a timing chart showing an example of an operation of the electro-optical device 1. For the sake of description, a horizontal synchronization signal Hsync, the scanning signals Y1 to Y3, the selection signals SEL[1] to SEL[k] corresponding to the scanning signals Y1 to Y3 at high level timing, and the video signal S[1] to S[n] are shown. In the video signal S[j], the data written to the pixels 111 in the [k× j− k+1]th to the [k× j]th columns, which is the k pieces of pixels 111 in the corresponding pixel group, is time-division multiplexed. In addition, in this example, in a case where S[j] is S[2t− 1], the video signal S is supplied from the first drive circuit 22 to the data lines 114 of the odd numbered pixel groups via the video signal input terminal 161A and the video signal line 160A. In a case where S[j] is S[2t], the video signal S is supplied from the second drive circuit 32 to the data lines 114 of the even numbered pixel groups via the video signal input terminal 161B and the video signal line 160B. For example, the video signals S[1] and S[2] are the video signal S supplied to the video signal input terminal 161A and the video signal input terminal 161B, respectively. In this example, k=4, and the four data lines 114 are sequentially arranged in the lateral direction. In the video signal S1 to S(2t− 1), the data to be written to the pixels 111 in the first, the second, the third, and the fourth column to the (8t− 7)th, the (8t− 6)th, the (8t−5)th, and the (8t− 4)th column is time-division multiplexed, in the video signal S2 to S(2t), the data to be written to the pixels 111 in the fifth, the sixth, the seventh, and the eighth column to the (8t− 3)th, the (8t− 2)th, the (8t−1)th, and the (8t)th column is time-division multiplexed. The number written in the waveforms of the video signal in the diagram shows the data lines 114 to which the signal thereof is supplied. For example, data in the period marked “1” in the video signal S1 is supplied to the data line 114 in the first column.

By using the two drive circuits of the first drive circuit 22 and the second drive circuit 32, it is possible to write data to the pixel which is twice as large in one period as compared with the case where these drive circuits are used alone. As described above, the first drive circuit 22 and the second drive circuit 32 are provided in different wiring substrates (the first wiring substrate 20 and the second wiring substrate 30), respectively. By arranging the video signal input terminal 161A to which the video signal supplied from the first drive circuit 22 is input and the video signal input terminal 161B to which the video signal supplied from the second drive circuit 32 is input in the longitudinal direction, it is possible to achieve smaller size and higher definition as compared with the case where these are arranged in the lateral direction. In addition, high-speed driving becomes also easier.

### 3. Application Example

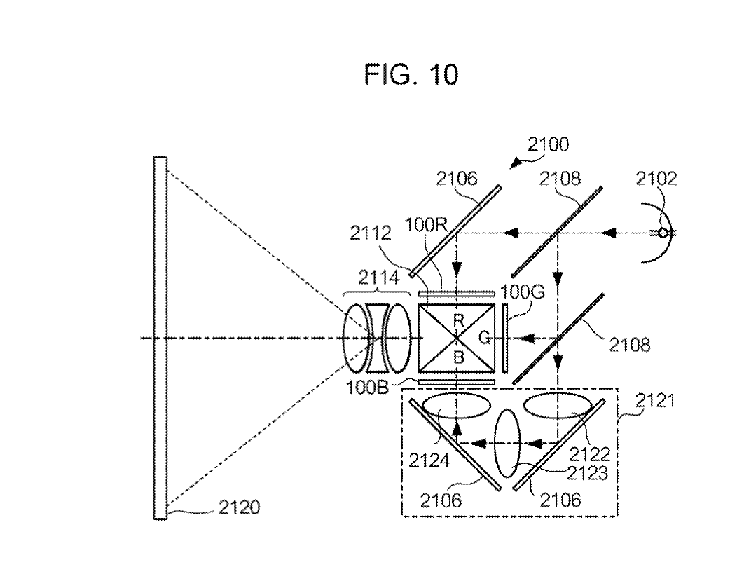

FIG. 10 is a diagram showing a projector 2100 according to one embodiment. The projector 2100 is an example of the electronic apparatus using the electro-optical device 1. In the projector 2100, the electro-optical device 1 is used as a light valve, and high-definition and bright display can be achieved without enlarging the device. As shown in the diagram, a lamp unit 2102 having a white light source such as a halogen lamp is provided inside the projector 2100. The projected light emitted from the lamp unit 2102 is separated into three primary colors, red (R) color, green (G) color, and blue (B) color by three mirrors 2106 and two dichroic mirrors 2108 provided inside the lamp unit 2102. The separated projection light is guided to light valves 100R, 100G, and 100B corresponding to the respective primary colors. Since the B color light has a long optical path as compared with the other R color and G color, in order to prevent the loss thereof, the light of the B color is guided through a relay lens system 2121 having an incidence lens 2122, a relay lens 2123, and an emission lens 2124.

In the projector 2100, three sets of liquid crystal display devices including the electro-optical device 1 are provided corresponding to R color, G color, and B color, respectively. The configuration of the light valves 100R, 100G and 100B is similar to that of the electro-optical panel 100 described above, and is connected to the upper circuit in the projector 2100 via the first wiring substrate 20 and the second wiring substrate 30. The video signals specifying the gradation level of each of the primary color components of R color, G color, and B color are supplied from the external upper circuit and processed in the upper circuit in the projector 2100, respectively, and the light valves 100R, 100G and 100B are driven, respectively. Light beams modulated by the light valves 100R, 100G, and 100B are incident to a dichroic prism 2112 from three directions, respectively. Then, in the dichroic prism 2112, the R color light and the B color light are refracted by 90 degrees, and the G color light travels straight. Therefore, after the images of each primary color are synthesized, a color image is projected on a screen 2120 by a projection lens group 2114.

Since light beams corresponding to each of the R, G, and B colors are incident to the light valves 100R, 100G, and 100B by the dichroic mirror 2108, it is not necessary to provide a color filter. In addition, the transmission images of the light valves 100R and 100B are projected after being reflected by the dichroic prism 2112, whereas the transmission image of the light valve 100G is projected as it is. Therefore, the horizontal scanning direction by the light valves 100R and 100B is a direction opposite to the horizontal scanning direction by the light valve 100G, and an image in which the left and right thereof are reversed is displayed.

### 4. Modification Example

The aspect of invention is not limited to the above-described embodiments, and various modifications can be made. Several modification examples will be described below. Two or more of the modification examples below may be used in combination.

The number of the wiring substrates bonded with the electro-optical panel 100 is not limited to two. Three or more wiring substrates may be bonded to the electro-optical panel 100. In the above embodiment, since the two wiring substrates are used, the terminal group is arranged in two stages, but for example in a case where three wiring substrates are used, the terminal group will be arranged in three stages.

The thickness of the power line may be the same as or less than that of a video signal line. If the thickness of the power line is equal to or less than that of the video signal line, it is possible to reduce the space for the power line.

The electro-optical panel 100 is not limited to a transparent liquid crystal panel. The electro-optical panel 100 may be a reflective type liquid crystal panel. In addition, the liquid crystal used is not limited to a VA type liquid crystal, but other types of liquid crystals such as a Twisted Nematic (TN) type and an In Plane Switching (IPS) type may be used. Alternatively, the electro-optical panel 100 may use electro-optical elements other than a liquid crystal, such as a Digital Mirror Device (DMD) and an organic Electroluminescence (EL) element.

The electronic apparatus using the electro-optical panel 100 is not limited to the projector 2100 illustrated in FIG. 10. The electro-optical panel 100 may be applied to an electronic apparatus having a direct view type display device such as a television, an electronic view finder, a car navigation device, a pager, an electronic organizer, an electronic calculator, a word processor, a workstation, a video phone, a POS terminal, a digital still camera, a mobile phone, a smartphone, a tablet type terminal, or the like.

Priority is claimed under 35 U.S.C. §119 to Japanese Application No. 2016-146309 filed on Jul. 26, 2016, which is hereby incorporated by reference in its entirety.

What is claimed is:

1. An electro-optical device comprising:
a first substrate;
a first terminal group in which a first video signal input terminal and a first non-video signal input terminal are arranged in a peripheral portion of the first substrate in a first direction;
a second terminal group in which a second video signal input terminal and a second non-video signal input terminal are arranged in a second direction different from the first direction with respect to the first terminal group and are arranged in the peripheral portion of the first substrate in the first direction; and
a first wiring that connects the first non-video signal input terminal and the second non-video signal input terminal.

2. The electro-optical device according to claim 1,
wherein the first video signal input terminal is connected to a first video signal line extending in the second direction,
the second video signal input terminal is connected to a second video signal line extending in the second direction, and
the first video signal line and the second video signal line are not connected.

3. The electro-optical device according to claim 1,
wherein the first non-video signal input terminal is connected with the first non-video signal line extending in the second direction.

4. The electro-optical device according to claim 1,
wherein the first wiring has a thicker wiring width than the first video signal line and the second video signal line.

5. The electro-optical device according to claim 3,
wherein the first non-video signal line has a thicker wiring width than the first video signal line and the second video signal line.

6. The electro-optical device according to claim 1,
wherein the first video signal input terminal and the second video signal input terminal have the same position in the first direction, and
the first non-video signal input terminal and the second non-video signal input terminal have the same position in the first direction.

7. The electro-optical device according to claim 1,
wherein the first terminal group is arranged in a peripheral area on one side of the first substrate, and
the second terminal group is arranged on the substrate end side with respect to the first terminal group in the peripheral area on one side of the first substrate.

8. The electro-optical device according to claim 1, further comprising:
a first wiring substrate that supplies video signals to a first pixel group; and
a second wiring substrate that supplies video signals to a second pixel group,
wherein the first wiring substrate is connected to the first terminal group, and
the second wiring substrate is connected to the second terminal group.

9. The electro-optical device according to claim 7,
wherein the first non-video signal input terminal is supplied with a source voltage from the first wiring substrate, and
the second non-video signal input terminal is supplied with the same source voltage from the second wiring substrate.

10. The electro-optical device according to claim 4, further comprising:
a scanning line drive circuit that is provided in a peripheral portion of the first substrate,
wherein the first wiring substrate is provided with a first drive circuit, and
the second wiring substrate is provided with a second drive circuit.

11. An electro-optical device comprising:
a first substrate;
a first terminal group that includes a first video signal input terminal and a first power supply terminal and is arranged in the first substrate in a first direction;
a second terminal group that includes a second video signal input terminal and a second power supply terminal, and is arranged in a second direction different from the first direction with respect to the first terminal group and arranged in the first substrate in the first direction; and
a first wiring that is formed on the first substrate and connects the first power supply terminal and the second power supply terminal.

12. The electro-optical device according to claim 11,
wherein the first wiring has a thicker wiring width than a wiring connected to the first video signal input terminal and a wiring connected to the second video signal input terminal.

13. The electro-optical device according to claim 11,
wherein the first video signal input terminal and the second video signal input terminal have the same position in the first direction, and
the first power supply terminal and the second power supply terminal have the same position in the first direction.

14. The electro-optical device according to claim 11,
wherein the first terminal group is arranged in the peripheral area on one side of the first substrate, and
the second terminal group is arranged on the substrate end side with respect to the first terminal group in the peripheral area on one side of the first substrate.

15. The electro-optical device according to claim 11, further comprising:
a second substrate that is opposite to the first substrate;
an electro-optical layer that is sandwiched between the first substrate and the second substrate;
a third power supply terminal and a fourth power supply terminal that are included in the first terminal group;
a fifth power supply terminal and a sixth power supply terminal that are included in the second terminal group;
a wiring that connects the third power supply terminal and the fifth power supply terminal;
a wiring that connects the fourth power supply terminal and the sixth power supply terminal;
a plurality of pixels; and
a drive circuit for selecting a group of pixels from the plurality of pixels,
wherein a reference potential of the voltage applied to an electro-optical layer is given to the first power supply terminal and the second power supply terminal,
a reference potential in the drive circuit is given to the third power supply terminal and the fifth power supply terminal, and
a power supply potential in the drive circuit is given to the fourth power supply terminal and the sixth power supply terminal.

16. The electro-optical device according to claim 15, further comprising:
the first wiring substrate that is connected to the first terminal group; and
the second wiring substrate that is connected to the second terminal group,
wherein the first wiring substrate and the second wiring substrate supply a reference potential of the voltage applied to the electro-optical layer, a reference potential in the drive circuit, and a power supply potential in the drive circuit,
the first wiring substrate supplies video signals to the first video signal input terminal, and
the second wiring substrate supplies video signals to the second video signal input terminal.

17. The electro-optical device according to claim 16,
wherein the first wiring substrate is connected to the first terminal group, and
the second wiring substrate is connected to the second terminal group.

18. The electro-optical device according to claim 16,
wherein the first wiring substrate is provided with a first drive circuit, and
the second wiring substrate is provided with a second drive circuit.

19. An electronic apparatus comprising:
the electro-optical device according to claim 1.

20. An electronic apparatus comprising:
the electro-optical device according to claim 11.
